(19) United States
(12) Patent Application Publication
(10) Pub. No.: US 2008/0170159 A1
(43) Pub. Date: Jul. 17, 2008

(54) VIDEO SIGNAL PROCESSING METHOD, VIDEO SIGNAL PROCESSING APPARATUS, DISPLAY APPARATUS

(76) Inventors: Yasuhiro Akiyama, Ome (JP); Koichi Hamada, Yokohama (JP); Hideharu Hattori, Kawasaki (JP); Masahiro Kageyama, Hino (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/874,951

(22) Filed: Oct. 19, 2007

(30) Foreign Application Priority Data
Nov. 6, 2006 (JP) 2006-299819

(51) Int. Cl. H04N 5/00; H04N 5/66

(52) U.S. Cl. 348/608; 348/739; 348/E05.001; 348/E05.133

(57) ABSTRACT

For achieving a video display of high picture quality, a video signal processing method comprises the following steps of: a step for produce a sub-field light-ON pattern signal for controlling light-ON or -OFF at a pixel, during said plural number of sub-field periods, depending a pixel value of the pixel in the input video; and a signal correcting step for correcting said sub-field light-ON pattern signal, with using a motion vector obtained through a motion vector search, which is conducted on a first frame in said input video and a second frame, time-sequentially prior to said first frame, wherein said sub-field light-ON pattern signal has light-ON pattern signal for each pixel during each of the sub-field periods between said second frame and said first frame, and said signal correcting step determines the light-ON pattern information of one pixel during one sub-field period, with using a motion vector passing said one pixel within said sub-field among said motion vectors, while determining light-ON pattern information during said one sub-field of said one pixel when there is no motion vector passing through said one pixel, whereby producing a new sub-field light-ON pattern signal having the light-ON pattern information newly determined.

### BACKGROUND OF THE INVENTION

(1) Field of the Invention

The present invention relates to a technology for reducing a dynamic false contour (or, a moving picture pseudo-outline)

(2) Description of the Related Art

As the technology for reducing the dynamic false contour is already known a technology, for building up a sub-field in a moving direction of pixels, by referring to a motion vector of the pixels, thereby correcting it, as is disclosed, for example, in Japanese Patent Laying-Open No. 2000-163004 (2000), etc.

### SUMMARY OF THE INVENTION

With the conventional correcting method with using the motion vector therein, since omission is generated of the light-ON information within the sub-field after the correction, it is impossible to achieve both, i.e., reducing the dynamic false contour and preventing the omission of the light-ON information within the sub-field, and therefore, there is a drawback that it is difficult to obtain a video display with high picture quality.

The present invention, accomplished by taking the drawback mentioned above into the consideration thereof, achieves a video display of high picture quality.

According to the present invention, for accomplishing the object mentioned above, there is provided a video signal processing method, for dividing one (1) field period in an input video into a plural number of sub-field periods, and producing a signal for controlling light-ON or -OFF during each period of said plural number of sub-periods, comprising the following steps of: a step, which is configured to produce a sub-field light-ON pattern signal for controlling light-ON or -OFF at a pixel, during said plural number of sub-field periods, depending a pixel value of said pixel in said input video; and a signal correcting step, which is configured to correct said sub-field light-ON pattern signal, with using a motion vector obtained through a motion vector search, which is conducted on a first frame in said input video and a second frame, time-sequentially prior to said first frame, wherein said sub-field light-ON pattern signal has light-ON pattern signal for each pixel during each of the sub-field periods between said second frame and said first frame, and said signal correcting step determines the light-ON pattern information of one pixel during one sub-field period, with using a motion vector passing said one pixel within said sub-field among said motion vectors, while determining light-ON pattern information during said one sub-field of said one pixel when there is no motion vector passing through said one pixel, whereby producing a new sub-field light-ON pattern signal having the light-ON pattern information newly determined.

With such the structures mentioned above, it is possible to achieve the video display of high picture quality, while achieving or satisfying the both, i.e., reducing the dynamic false contour and preventing the omission of the light-ON information within the sub-field.

Thus, according to the present invention, it is possible to accomplish the video display of high picture quality.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a view for showing an example of the structures of a video signal processing apparatus, according to an embodiment of the present invention;

FIG. 2 is a view for showing an example of the principle of light emission of a pixel in PDP, or the like;

FIG. 3 is a view for showing a mechanism of generating the dynamic false contour;

FIG. 4 is a view for showing the conventional method for compensating the dynamic false contour;

FIG. 5 is a view for showing the problem to be dissolved, in relation to the conventional method for compensating the dynamic false contour;

FIG. 6 is a view for showing an example of the structures of a sub-field converter portion, according to an embodiment of the present invention;

FIG. 7 is a view for showing an example of definition of the motion vector information, according to the embodiment of the present invention;

FIGS. 8(a) and 8(b) are views, each for showing an example of a method for detecting the motion vector, according to the embodiment of the present invention;

FIGS. 9(a) and 9(b) are views, each for showing an example of operation of an intermediate sub-field frame producer portion, according to the embodiment of the present invention;

FIGS. 10(a) to 10(d) are views, each for showing an example of a method for disposing a light-ON pattern information, according to the embodiment of the present invention;

FIG. 11 is a view for shown one example of the configuration of an intermediate sub-field frame, according to the embodiment of the present invention;

FIG. 12 is a view for shown one example of a method for producing a present frame after correcting, according to the embodiment of the present invention;

FIG. 13 is a view for showing a flow of a video signal processing method, according to the embodiment of the present invention;

FIG. 14 is a view for showing an example of a video signal processor apparatus, according to the embodiment of the present invention; and

FIG. 15 is a view for showing an example of a video signal processor apparatus, according to the embodiment of the present invention.

### DESCRIPTION OF THE PREFERRED EMBODIMENTS

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

Hereinafter, embodiments according to the present invention will be fully explained by referring to the attached drawings. However, in the following will be made explanation on an example of a display device for expressing predetermined gradations by means of a pleural number of sub-fields, such as, a plasma display apparatus, etc., as an example thereof.

And, in each of figures, it is assumed that every constituent element attached with a same reference numeral has the same function thereof.

Also, a mentioning “SF” in the description of the present specification and every drawings attached wherewith is an abbreviation of “sub-field”. Or, mentioning “SF” or “sub-field” includes a meaning of a “period of the sub-field”.

Also, an expression “dispose information” in the present specification and every drawings attached wherewith includes a meaning that the information is stored in a part of data, or that information is determined to be stored.

And also, an expression “video” in the present specification and every drawings attached wherewith has a meaning including, not only one (1) piece of picture, video data, or video information, but also so-called video, such as, video made of a plural number of frames, video data, video information, or the like, and also picture data, picture information, moving picture, moving picture data and moving picture information, etc.

### EMBODIMENT 1

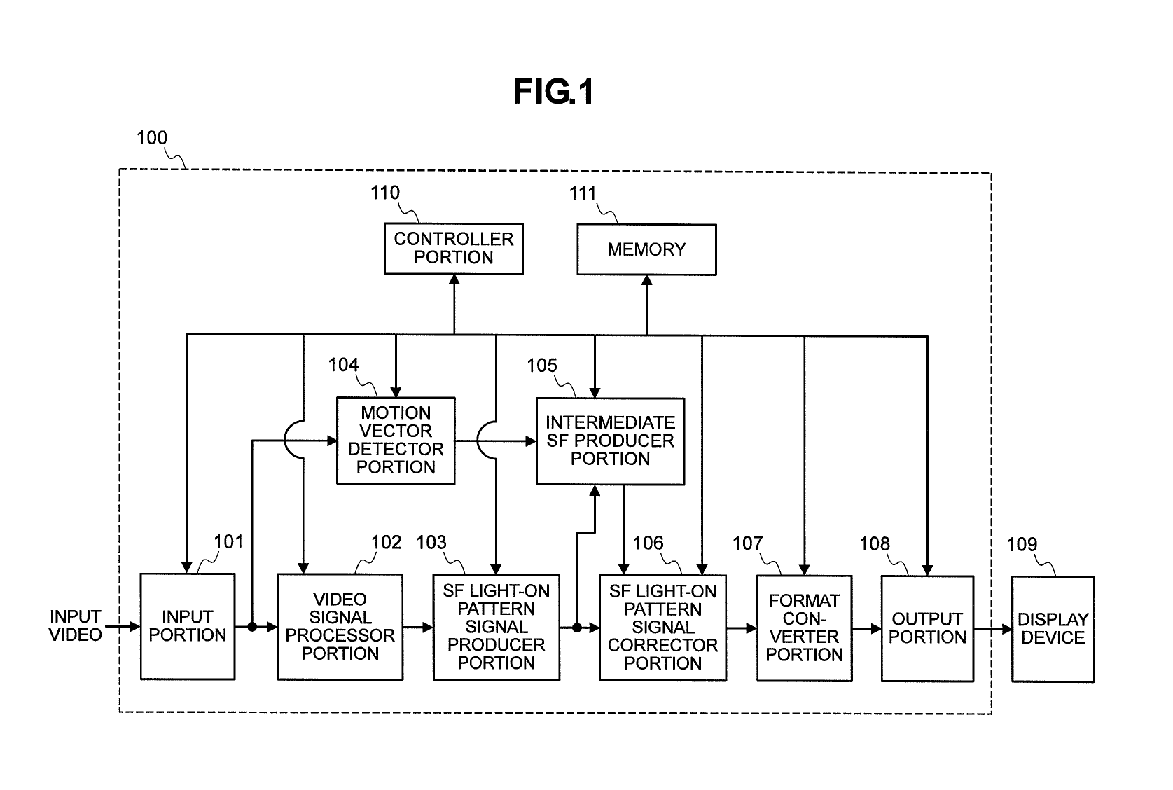

FIG. 1 shows an example of the structures of a video signal processing apparatus 100, according to the present invention. The video signal processing apparatus 100 shown in FIG. 1 is constructed with constituent elements, each conducting the following operations.

In the video signal processing apparatus 100, first of all, video inputted into an input portion 101 is transferred into a video signal processor portion 102, a motion vector detector portion 104, and an intermediate sub-field frame producer portion 105 (hereinafter, being described, an “intermediate SF frame producer portion” 105). The video signal processor portion 102 conducts signal processing, such as, a gain adjustment or control and the reverse gamma (“γ”) correction, etc., depending a pixel value of the input video, so as to brining the color expression, brightness gradation and soon, into appropriate conditions thereof, when projecting the video on a display device 109. A sub-field light-ON pattern signal producer portion 103 (hereinafter, being described, a “SF light-ON signal producer portion” 103) conduct conversion from the pixel value into a SF light-ON pattern signal, for transmitting the pixel value after the video signal processing to a light-ON controller portion of the display device 109, as a light-ON pattern signal. The motion vector detector portion 104 detects a motion vector (an amount of movement and a moving direction) for each pixel, for example, by referring to two (2) pieces of input videos, continuing time-sequentially. The intermediate SF frame producer portion 105 produces virtual “N” pieces of intermediate frames corresponding to each SF light-ON time position, at the each SF light-ON time position, by referring to the SF light-ON pattern signal, which the SF light-ON signal producer portion 103 outputs, and the motion vector which the motion vector detector portion 104 detects. A sub-field light-ON pattern signal corrector portion 106 (hereinafter, being described, a “SF light-ON pattern signal corrector portion” 106) re-constructs the pixel value by referring to the “N” pieces of intermediate frames. A format converter portion 107 multiplies the video re-conducted with a video sync signal, etc., and an output portion 108 outputs to the display device 109. Herein, the display device 109 may be, for example, a plasma panel display (hereinafter, being described, a “PDP”), etc.

Thus, within the video signal processing apparatus 100, for example, one (1) field period is divided into a plural number of sunshield periods, thereby to control ON or OFF of lighting, during each time period of that plural number of sub-field periods. With this, it is possible to achieve a video signal processing for producing a signal for controlling the brightness of pixel during one (1) field period.

Hereinafter, it is assumed that “correction of the light-ON pattern during the sub-field” means a process for changing the disposition or position of the light-ON pattern information, in each sub-field, which is included in the sub-field light-ON pattern signal produced by the SF light-ON pattern signal producer portion 103.

However, operation of each constituent element of the video signal processing apparatus 100, according to the present embodiment, maybe autonomous one of the each constituent element, or may be achieved by a controller portion 110 shown in FIG. 1, in cooperation with software held in a memory 111, etc. Or, the controller portion 110 may also control the operation of each constituent element. Also, data calculated or detected in each constituent element may be recorded on a data recorder portion owned by the each constituent element, but may be recorded in the memory 111 shown in FIG. 1.

Also, the intermediate SF frame producer portion 105 and the SF light-ON pattern signal corrector portion 106 in the video signal processing apparatus 100, according to the present embodiment, they are described to be separated from each other, in the explanation thereof, however they may be constructed by combing both, i.e., one (1) SF light-ON signal corrector portion.

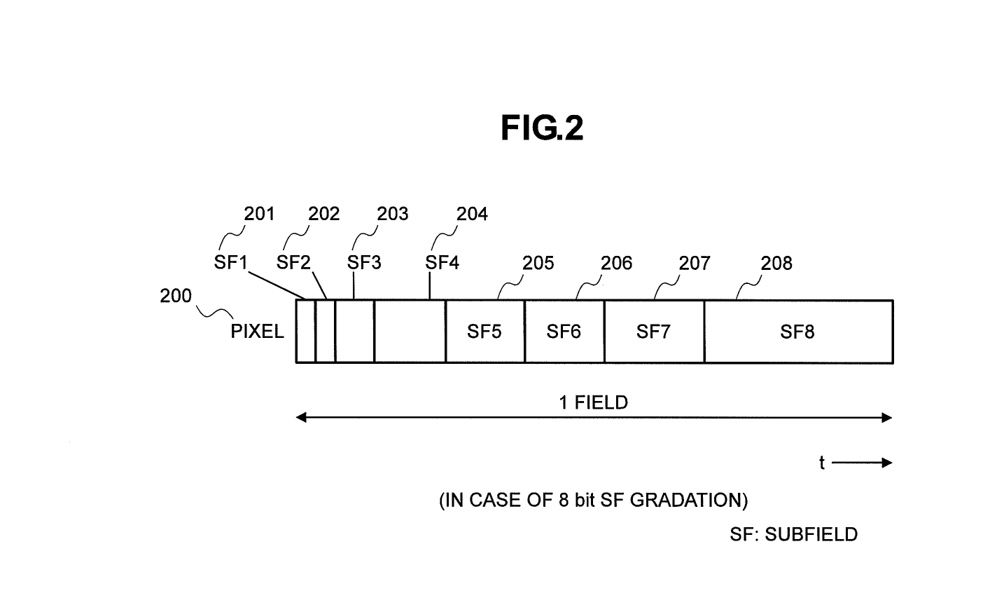

FIG. 2 is a view for showing an example of the principle of light emission of a pixel in PDP, or the like. For example, in the PDP or the like, the lighting (i.e., light-ON) is achieved by irradiating ultraviolet rays upon a phosphor on the panel surface, in a pulse-like manner. Herein, gradation of the brightness on a pixel is expressed or represented by adjustment of the time-length of that light emission, for each field. In general, combing the light-ON and light-OFF during “N” pieces of sub-fields, which are distributed to a predetermined light emission time deals with the change of brightness gradation. FIG. 2 shows an example, where the gradation is represented by “SF” having eight (8) kinds of weights, SF1 to SF8 (201 to 208), for example. For eyes of a human, a total amount of light emission of the SF1 to SF8 (201 to 208) is acknowledged as the brightness gradation per one (1) field.

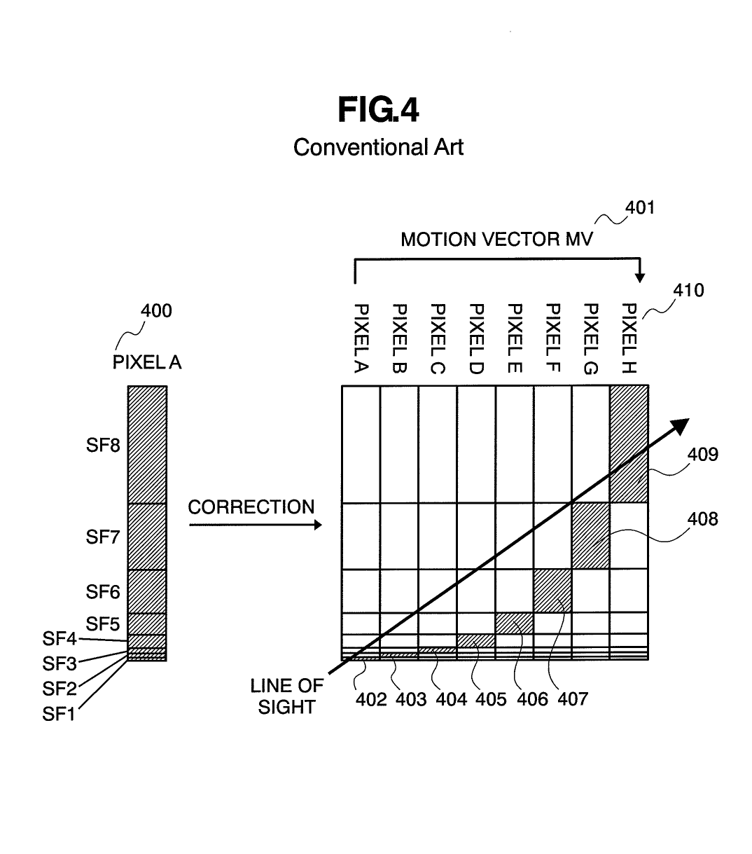

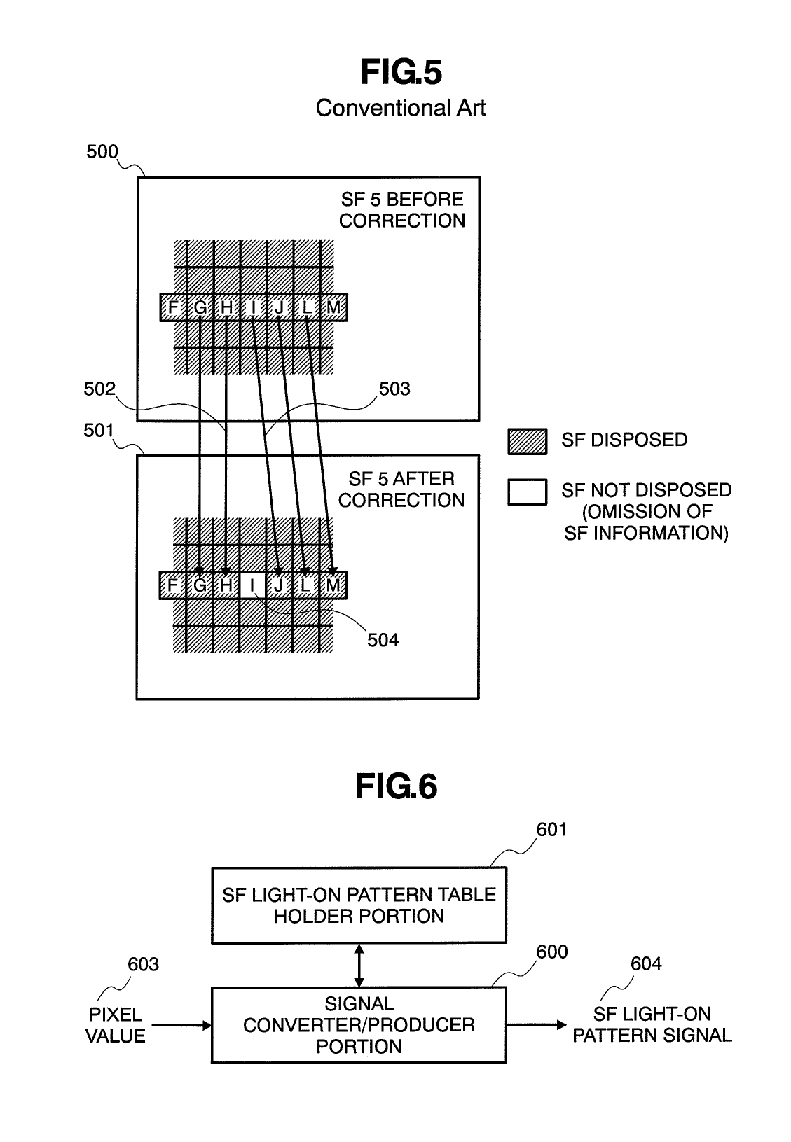

Herein, explanation will be made on an example of representing the gradation by “SF” having eight (8) kinds of weights (length of the period), with the similar structure of the sub-field shown in FIG. 2. However, this is only an example, and as the structure of the sub-field may be applied any conventional SF light-ON pattern. For example, the number of pieces of the sub-fields may be larger or smaller that the eight (8) pieces. Or, there is no necessity that all of the sub-fields have the weights, each differing from one another, as is shown in the example of the structure of that sub-field. There is no problem if providing a plural number of sub-fields, each having the same weight. For example, the structure disclosed in FIG. 4 of Japanese Patent Laying-Open No. 2006-163283 (2006) or in FIG. 5 of Japanese Patent Laying-Open No. 2002-023692 (2002) maybe applied into the present invention.

Also, since the PDP, etc., is constructed with light emission devices of three (3) floors, R(red), G(green), and B(blue), in general, then three (3) sets of SF groups are used for one (1) pixel. However, in the explanation on the embodiment of the present invention, for the purpose of easy understanding of the structures thereof, explanation will be made with an assumption that one (1) set of SF group is used for each one (1) pixel. When applying the embodiment, which will be mentioned below, into light emissions of a plural number of colors, such as, R(red), G(green), and B(blue), it is enough that the pixels in the embodiment mentioned below have the data of color to be written, respectively.

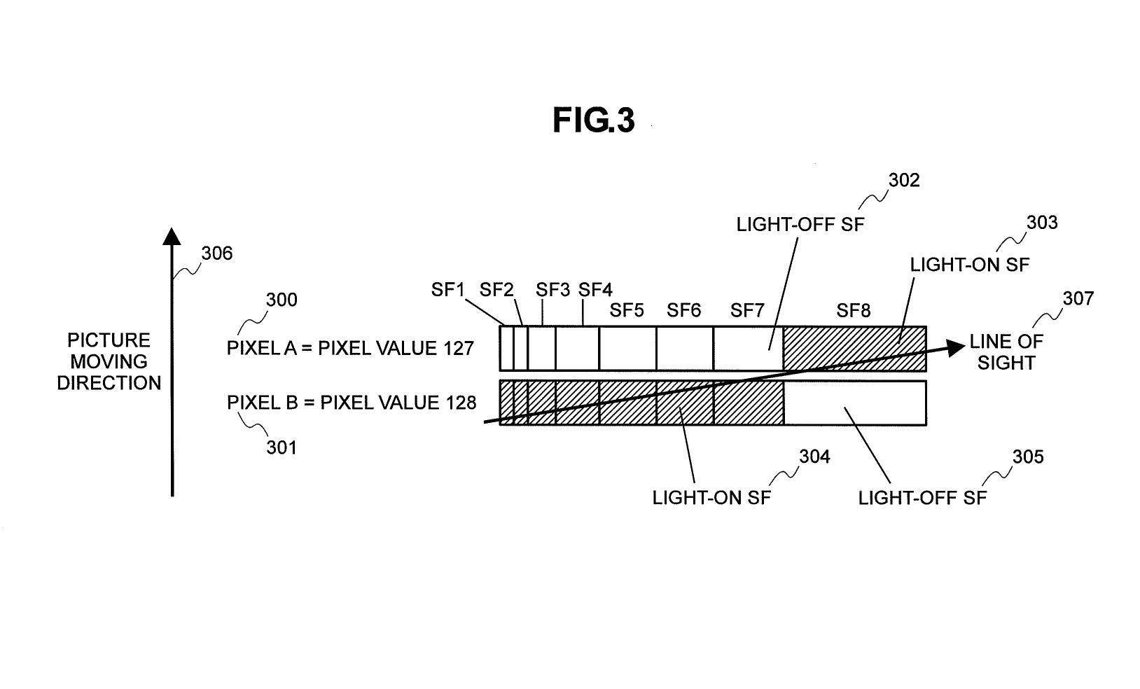

FIG. 3 is a view for showing a mechanism of generating the dynamic false contour in the PDP, etc.

In general, no dynamic false contour is generated on a moving picture. However, when reproducing the moving picture, due to the light emission structures of the PDP or the like, shown in FIG. 2, there is a case or possibility that human eyes are confused a pixel to have the brightness gradation different from the original pixel display value upon a specified video pattern. It is assumed, as shown in FIG. 3, there is a picture area where a pixel A (300) having the pixel value of “127” and a pixel B having the pixel value of “128”, for example. In the pixel A (300), SF1 to SF7 are the light-OFF SF (302) and SF8 is the light-ON SF (303). In the pixel B (301), SF1 to SF7 are the light-ON SF (304) and SF8 is the light-OFF SF. In case when this picture area is moved into a picture moving direction 306 shown in the figure, since the human eyes have a nature to follow also into that moving direction, therefore the SF light-ON pattern comes into the brightness gradation on a line of sight 307, shifting from the original brightness gradation of the pixel. In case of the example shown in the same figure, it can be considered that it is erroneously acknowledged to be of the brightness gradation near to “255” when lighting almost all of the SFs, shifting from the original gradations of the pixel A (300) and the pixel B (301), greatly.

FIG. 4 is a view for showing the conventional method for compensating the dynamic false contour. As the conventional method for compensating the dynamic false contour is disclosed a method, wherein detection is made on a motion vector MV (401) indicating the moving direction of and moving amount of the picture, and re-construction is made by disposing SFs for building up the pixel into the motion vector, thereby reducing the dynamic false contour by bringing the disposal of SFs to the direction of the line of sight. Hereinafter, explanation will be made on an example thereof. What is shown on the left-hand side in FIG. 4 is light-ON pattern information during each sub-field of the pixel A. Also, what is shown on the right-hand side in FIG. 4 is an example of disposing the light-ON pattern information during each sub-field of the pixel A, wherein the vertical axis indicates the sub-field (time) while the horizontal axis the pixels in the direction of the motion vector. In case where the motion vector MV (401) is a motion vector of a pixel A (400) moving into the horizontal direction towards a pixel H (410), for example, eight (8) pieces of SFs of weight building up the original pixel A (401) are re-disposed from the pixel A (400) to the pixel H (410). In more details, disposing of SF is made in the following steps; i.e., disposing SF1 to SF1 (402) of the pixel A, SF2 to SF2 (403) of the pixel B, SF8 to SF8 (409) of the pixel H, thereby making correction thereon.

FIG. 5 is a view for showing the problem to be dissolved, in relation to the conventional method for compensating the dynamic false contour, wherein comparison is made on the light-ON pattern information during one (1) sub-field, before and after the correction, with using the conventional motion vector. In FIG. 5, reference numerals 500 and 501 show the sub-field light-ON pattern information (hereinafter, being described, “SF light-ON pattern information”) of SF5 before the correction and after the correction (i.e., a corrected picture), respectively, on a 2-dimensional pixel plane. Although mentioning is made on the SF5, in the present figure, for the purpose of explanation, but it is only an example, and this is same to the other sub-field.

Herein, arrows shown in the figure indicate movements of the SF light-ON pattern information, before and after the correction thereof. Those movements are generated because of the disposition with using the motion vector, as was explained in FIG. 4. In this instance, depending on the condition of direction of movement of the picture or an accuracy of detection of the motion vector, there maybe a case or possibility of generating the movement of the SF light-ON pattern information, as shown in FIG. 5. Thus, in the example shown in FIG. 5, the SF light-ON pattern information of the pixels G and H makes no movement, but the SF light-ON pattern information of the pixels I, J, K and L shift by one (1) pixel into the right-hand direction. In this instance, within the SF light-ON pattern information of SF5 after the correction, there is no SF light-ON pattern information, which should be disposed to the pixel I, and therefore omission is generated for the SF light-ON pattern information. Such the omission of the SF light-ON pattern information generates, also in the cases other than that shown in FIG. 5, such as, when the accuracy for detecting the motion vector is incomplete, when there is a quantumization error or the like upon calculation of the disposing position thereof, or when a plural number of motion vectors pass through the position of the same pixel on a predetermined SF, for example.

When such the omission of the SF light-ON pattern information, there exists a pixel, being incomplete of the SF light-ON pattern information thereof, i.e., only a part of the pixels are displayed with unnatural brightness, and this reduces the picture quality.

FIG. 6 is a view for showing an example of the structures of a SF light-ON pattern signal generator portion 103. The SF light-ON pattern signal generator portion 103 conducts conversion from the pixel value into the SF light-ON pattern signal, for transmitting the pixel value after video signal processing to a light-ON controller portion, which is comprised by the display device 109 shown in FIG. 1, as the sub-field light-ON pattern signal 604 (hereinafter, SF light-ON pattern signal 604). In the SF light-ON pattern signal generator portion 103 are prepared the information indicating all SF light-ON patterns corresponding to the pixel values, in advance, in the form of SF light-ON pattern table information within a sub-field light-ON pattern table holder portion 601 (hereinafter, being called, a “SF light-ON pattern table holder portion 601”). Next, a signal converter/generator portion 600 referring to this SF light-ON pattern table information determines the SF light-ON pattern from an input pixel value 603, and generates a SF light-ON pattern signal upon basis of this, as a SF light-ON pattern signal 604.

With such structures, it is possible to convert the pixel value of the video signal, preferably, into the SF light-ON pattern signal to be used in the processing after the SF light-ON pattern signal generator portion 103.

Herein, being similar to the explanation made in FIG. 2, the SF light-ON pattern tables, which are held by the SF light-ON pattern table holder portion 601, differ from each other, depending on the structures of the sub-fields to be applied. In each of the embodiments of the present invention, it does not matter to apply various structures of the sub-fields, which are shown as the examples in FIG. 2, other than the structure of the sub-field shown in FIG. 2. However, the SF light-ON pattern table information may be held in the memory 111 shown in FIG. 1, but not in the SF light-ON pattern table holder portion 601.

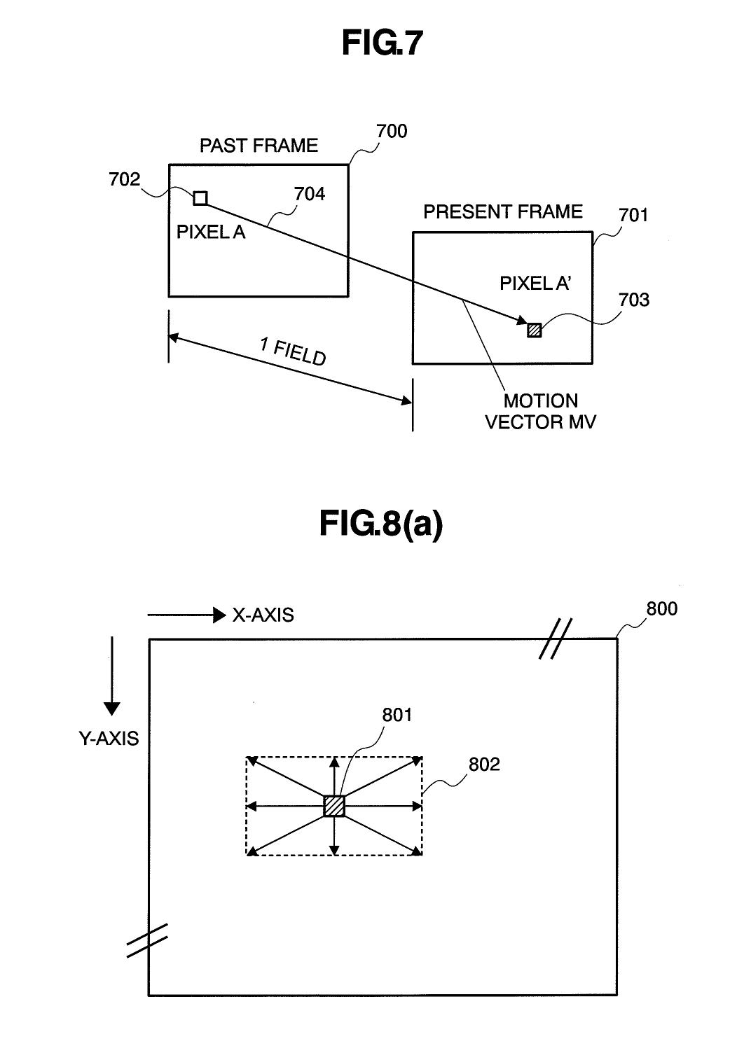

FIG. 7 is a view for showing an example of definition of the motion vector, which is outputted by the motion vector detector portion 104. Herein, the motion vector detector portion 104 conducts the motion vector detection by referring to two (2) pieces of frame, i.e., a present frame 701 and a past frame 700, which is time-sequentially prior to the present frame 701 by one (1) field. For example, it is assumed that the pixel A (702) of the past frame 700 moves to the position of the pixel A′ (703) of the present frame 701. The definition of the motion vector MV (704), which the motion vector detector portion 104 outputs in this instance, is outputted in the form of numerical value information (an amount of motion, and a direction of motion), expressing that the pixel A′ of the present frame 701 is moved from the pixel position of the pixel A (702) of the past frame 700.

However, the motion vector detected by the motion vector detector portion 104 may be recorded therein, with such structure that the motion vector detector portion 104 has a recording portion. Also, for example, the motion vector detector portion 104 may records the detected motion vector into the memory 111 shown in FIG. 1.

However, in case where such motion vector as was explained above is included within the video signals to be inputted into the input portion, it is not necessary to detect the motion vector, newly, in the motion vector detector portion 104. In this case, a necessary motion vector may be selected to be used, among from the motion vector information included in the video signal.

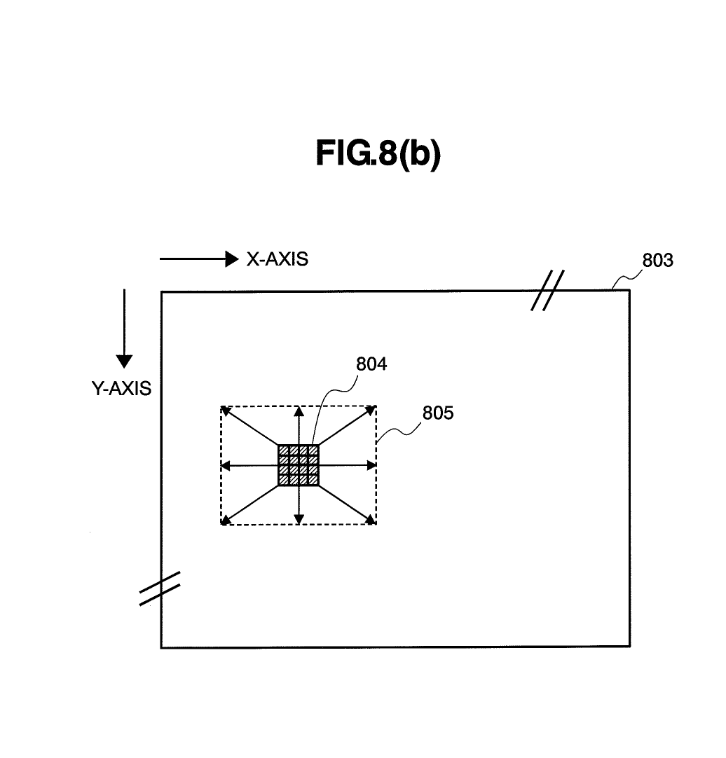

FIGS. 8(a) and 8(b) are views for showing examples of the methods within the detecting the motion vector detector portion 104. FIG. 8(a) shows a detecting method by comparing the pixels as one unit to each other, between the present frame and the past frame prior thereto by one (1) field. A reference pixel 801 is a pixel on the past frame. For example, the motion vector detector portion 104 searches a comparison pixel, which has the pixel value equal to or most nearest to the pixel value of the reference pixel 801, within a predetermined search area or region 802 on the present frame. In this instance, the predetermined search region 802 may be defined to be within a predetermined distance from a reference point, or in a predetermined shape, etc., on the frame of the reference pixel 801. Lastly, the motion vector detector portion 104 outputs the distance between the position of the reference pixel 801 on the frame and the position of the comparison pixel detected on the frame, and the direction thereof, as the motion vector.

FIG. 8(b) shows an example of a detecting method by comparing the pixel blocks to each other, each being constructed with plural pieces of pixels, between the present frame and the past frame prior thereto by one (1) field. A reference pixel block 804 is the reference pixel block on the past frame. Herein, for example, the motion vector detector portion 104 searches a comparison pixel block having an average pixel value equal to or nearest to an average pixel value of the reference pixel block 804, within a predetermined search area or region on the present frame. In this instance, the predetermined search region 805 may be defined to be within a predetermined distance from a reference point, or in a predetermined shape, etc., on the reference pixel block 804. Or, the search of the comparison pixel block should not limited only to the average pixel value, but also statistic information with using difference of each pixel value, between the reference pixel block 804 and the comparison pixel block, and/or an estimation function value of applying that difference as a variable. Lastly, the distance defined between the position of the representative point (for example, a center, etc.) of the reference pixel block on the frame and the position of the detected representative point (for example, a center, etc.) of the comparison pixel block on the frame, and the direction thereof are outputted as the motion vector. Also, herein, sizes (i.e., configuration) of the pixel block can be determined, freely. For example, it may be a square pixel block of n pixels×n pixels, or an oblong pixel block of n pixels×m pixels, or may be the pixel block of configuration, being circular, ellipse, or polygon, etc., in the shape thereof.

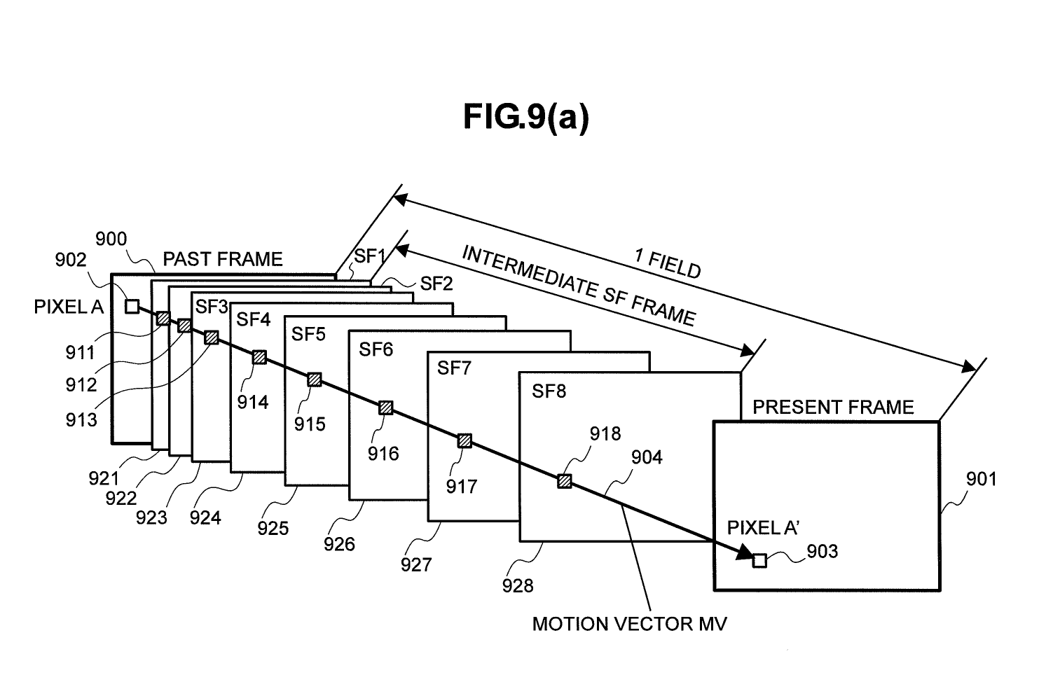

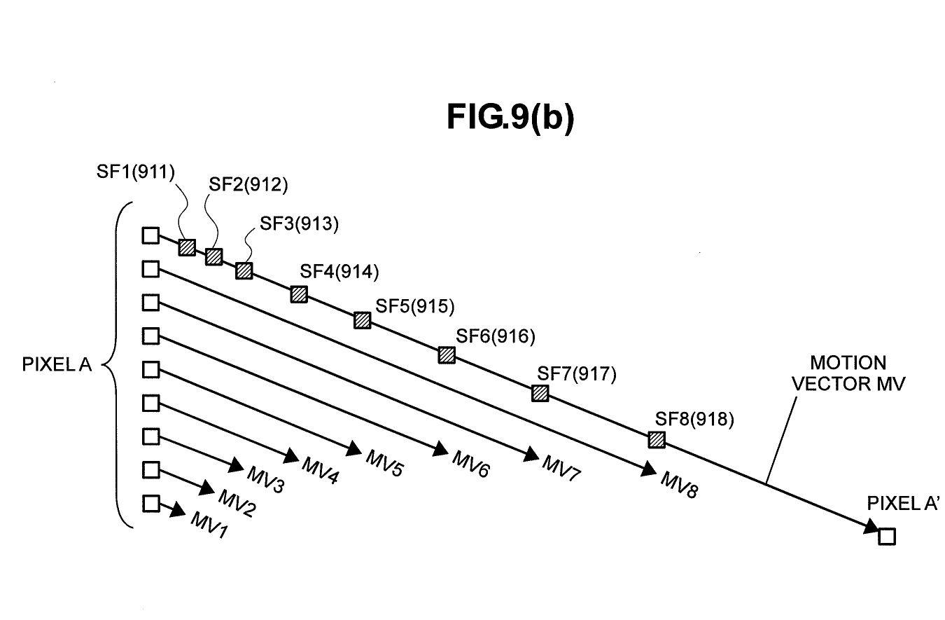

FIGS. 9(a) and 9(b) are view for showing an example of operations within the intermediate SF frame producer portion 105. In FIG. 9(a), the intermediate SF frame producer portion 105 produces imaginary or virtual intermediate SF frames 921 to 928, between the present frame 901 and the past frame 900 prior thereto by one (1) field. The intermediate SF frame producer portion 105 obtains the pixels on the past frame 900 corresponding to the pixels of the intermediate SF frames 921 to 928, respectively. Also, the intermediate SF frame producer portion 105 disposes the light-ON pattern information within the sub-field of that corresponding pixel to each pixel of each of the intermediate SF frames 921 to 928. Herein, in more details thereof, the intermediate SF frame is data, which is made up with binary data of a number of pixels of a frame, as one (1) frame, and a set of the binary data, including data of this one (1) frame in the number of the corresponding sub-fields, is held within the intermediate SF frame producer portion 105.

The intermediate SF frame producer portion 105 calculates the motion vector starting from the pixel of the past frame to each pixel of the intermediate SF frame, with using the motion vector, which is detected by the motion vector detector portion 105, when the pixel of the past frame moves to the pixel of the present frame. This calculation of the motion vector is conducted for each pixel of the each intermediate SF frame. With this, it is possible to obtain the motion vector for each pixel of the each intermediate SF frame. The light-On pattern information within the sub-field corresponding to the pixel on the past frame, i.e., a start point of this motion vector, is disposed, as the light-ON pattern information within the sub-field corresponding to the pixels of that intermediate SF frame. Also, among the pixels of the intermediate SF frame, in particular, regarding the pixel, through which the motion vector detected by the motion vector detector portion 104 does not pass, it is impossible to obtain the motion vector corresponding to that pixel, if being as it is. Herein, the pixel, through which the motion vector does not pass, means that no motion vector has an intersecting point with that intermediate SF frame on that pixel. Then, the intermediate SF frame producer portion 105 obtains the motion vector corresponding to that pixel, with using a substitution motion vector, which is selected and produced therein, for example. With using this motion vector is disposed the light-ON pattern information of the pixel of that intermediate SF frame, in the similar manner to that mentioned above.

The above-mentioned operation is conducted on each pixel of the each intermediate SF frame. With this, it is possible to dispose the light-ON pattern information for SF of each pixel of the each intermediate SF frame, with using the motion vector obtained, as well as, the SF light-ON pattern information of the pixel of the past frame, being a start point of that motion vector.

Hereinafter, detailed method for producing the intermediate SF frames 921 to 928. First of all, the intermediate SF frame producer portion 105 produces an imaginary or virtual frame corresponding to each SF, between the past frame 900 and the present frame 901. The position where this virtual frame is disposed on the time axis is a center or the like, during each SF period, for example. Also, this disposition on the time axis may be not at the center during the each SF period, but within the each SF period.

Next, it is assumed that the motion vector is a motion vector MV (904), when the pixel A (902) of the past frame 900 detected by the motion vector detector portion 104 moves to the pixel A′ (903) of the present frame 901. Herein, the intermediate SF frame producer portion 105 produces the motion vectors for each of the intermediate SF frames 921 to 928, with using the motion vector MV (904).

FIG. 9(b) shows an example of a method for producing the motion vectors for each of the intermediate SF frames, which are produced in the manner mentioned above. In this FIG. 9(b), the pixel A (902) of the past frame 900, i.e., the start point thereof, is depicted, shifting for each of the vectors, for the purpose of explanation. Each of the motion vectors MV1 to MV8 is in the direction same to that of the motion vector MV (904), but differs from that in the length thereof. Thus, each of the motion vectors MV1 to MV8 can be calculated, starting from the pixel A, as a start point, and reaching to the intersection point between the motion vector MV (904) and each of the intermediate SF frames 921 to 928, as an end point. Thus, the end point of each of the motion vectors MV1 to MV8 is the pixel, where the motion vector MV (904) passes through or intersect with each of the intermediate SF frames 921 to 928, respectively. This motion vector differs depending on the position on the time axis of the each virtual frame.

The intermediate SF frame producer portion 105 provides the light-ON pattern information of the SF, corresponding to the pixel A (902) of the past frame 900, to the light-ON pattern information at the pixel position, which is pointed by each of the motion vectors MV1 to MV8 of each of the intermediate SF frames 921 to 928. For example, the light-ON pattern information is given motion vector MV3 of the pixel A (902) of the past frame 900 is given to the pixel of the intermediate SF frame 923 for use of SF3, which the motion vector MV3 pointes.

Since in those FIGS. 9(a) and 9(b) are shown the examples of expressing the gradation by SF, which has eight (8) pieces of weights, i.e., SF1 to SF8, per one (1) pixel, therefore the intermediate SF frames are produced by eight (8) pieces thereof, corresponding to SF1 to SF8. For example, to the intermediate SF frame for SF1 is disposed SF1 of the pixel A (902), and to the intermediate SF frame for SF2 is disposed SF1 of the pixel A (902). Thereafter, SF is disposed, in the similar manner, from the intermediate SF frame for SF3 to the intermediate SF frame for SF8.

Also, the motion vector pointing upon the intermediate SF frame in FIG. 9(b) is produced, by detecting the motion vectors, each corresponding to all of the pixels on the intermediate SF frame, respectively, in accordance with the definition of the motion vector information shown in FIG. 7.

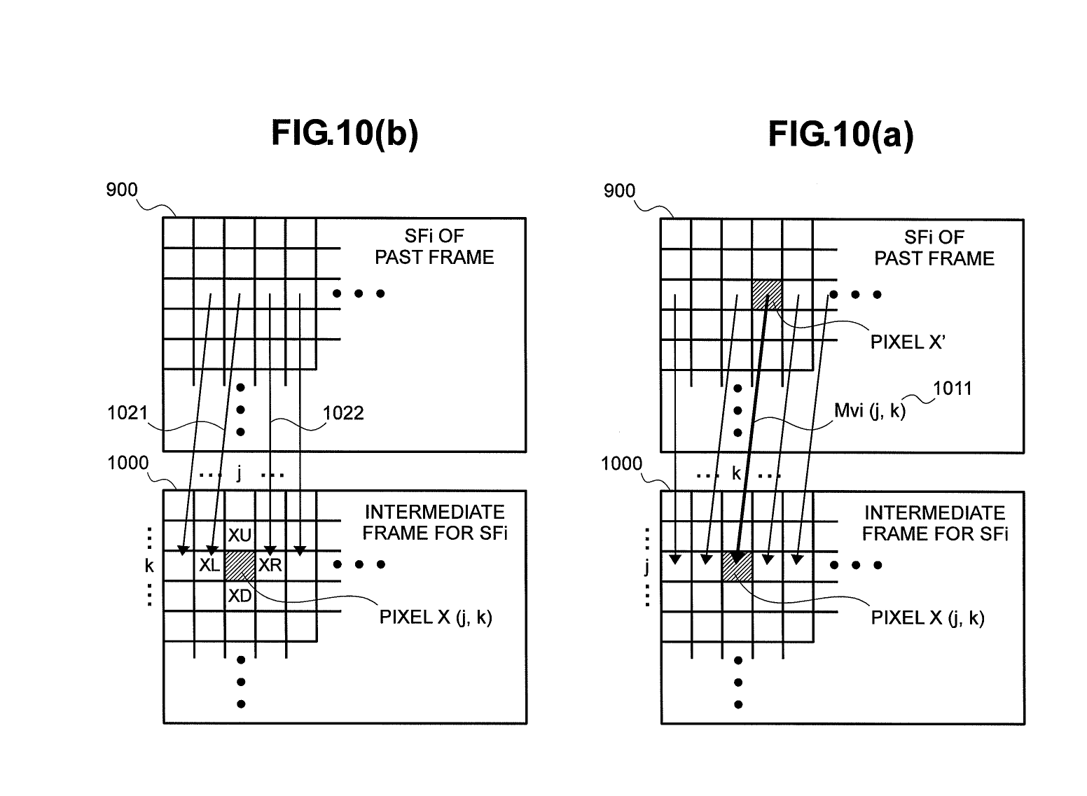

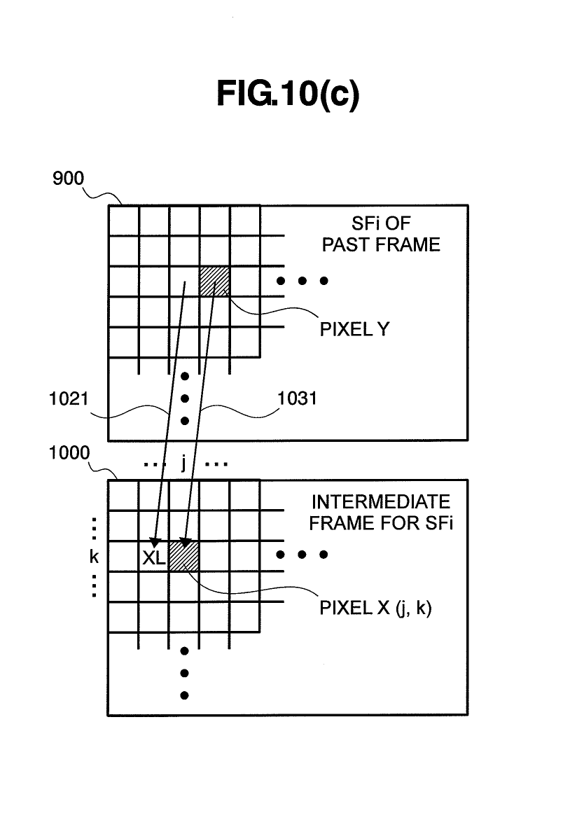

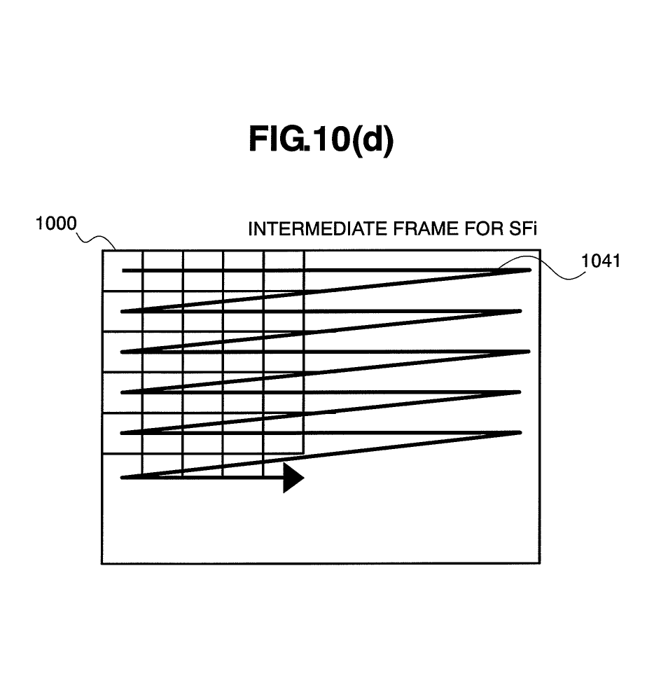

Next, details of the method for disposing the SF light-ON pattern information, by referring to FIGS. 10(a) to 10(d).

FIG. 10(a) shows an example of an intermediate frame 1000 for SFi, i.e., i^{th} intermediate frame, as well as, the past frame 900, shown in FIG. 9(a). The intermediate SF frame producer portion 105 firstly makes determination on whether there is the motion vector or not, starting from the past frame 900 and ending at a pixel X(j,k), as is shown in FIG. 10(a), regarding the pixel X(j,k) on the intermediate frame 100 for SFi. Herein, “j” and “k” are values, being indicative of the position of the pixel X in the horizontal direction (indicating a column number, in which the pixel X is included, within the frame) and the position in the vertical direction (indicating a raw number, in which the pixel X is included, within the frame), respectively.

Herein, in case where there is the motion vector starting from the past frame 900 and ending at the pixel X(j,k), this motion vector is determined as a vector MVi(j,k) for use in disposing of the light-ON pattern information. Thus, among transcription of mVi(j,k), “i” indicates that the vector ends by the I^{th} intermediate frame, and “j” and “k” that the vector ends at the pixel lying at the position (j,k) on the frame. In the example shown in FIG. 10(a) are shown the motion vectors, staring from the past vector 900, and ending at the pixel X(j,k) and two (2) other pixels on both sides thereof, respectively. Herein, a reference numeral 1011 is the vector MVi(j, k) . In this instance, the intermediate SF frame producer portion 105 can obtain a pixel X′ on the past frame 900, i.e., the start point of that vector, from the vector MVi(j,k). Next, among the light-ON information of the pixel X′ on the past frame 900, the light-ON pattern information at the i^{th} sub-field is disposed, as the light-ON pattern information at the pixel X(j, k) on the intermediate frame for SFi. Herein, the light-ON pattern information on the past frame 900 of the pixel X′ is included within the SF light-ON pattern signal, which is produced by the SF light-ON pattern signal generator portion 103, through the process shown in FIG. 6.

With conducting the disposing of the light-ON pattern information as shown in FIG. 10(a), it is possible to approach the light-ON pattern information of each SF of the past frame, to the motion vector following to the movement of a line of sight of a user. With this, there can be brought about an effect of reducing the dynamic false contour on the video display, in relation to the video signal outputted from the video signal processing apparatus 100.

Next, an example of the case is shown in FIG. 10(b) where there is no motion vector starting from the past frame 900 and ending at the pixel X(j,k). In this example shown in FIG. 10(b) are also shown the vectors, starting from the past frame 900 and ending at the pixel X (j,k) and other pixels on both sides thereof, respectively. However, the pixels at the end points of the vectors 1021 and 1022 are XL(j−1,k) and XR(j+1,k), and there is no vector starting from the pixel X(j,k).

In such case, as was explained in FIG. 5, according to the conventional method, the omission or failure is generated of the light-ON pattern information within the sub-field. Then, according to the present embodiment, for the purpose of preventing this omission or failure, the light-ON pattern information is disposed to the pixel X(j,k) in accordance with the method shown in FIG. 10(c).

In FIG. 10(c), the intermediate SF frame producer portion 105 produces a new motion vector, applying the motion vector ending at the neighboring pixel, thereby using it for disposition of the light-ON pattern information. In the example shown in FIG. 10(c), for example, a vector MVi(j,k) is produced by applying the motion vector ending at the pixel XL(j−1,k) neighboring to the pixel X(j,k) in the left-hand direction, for example. Thus, in this case, the intermediate SF frame producer portion 105 puts the end point of that applied motion vector onto the pixel X(j,k), thereby obtaining the pixel on the past frame, i.e., the start point of that vector. Thus, with producing the new motion vector, being equal to the motion vector starting from the pixel XL(j−1,k) and ending at the pixel X(j,k), the pixel is obtained where that vector starts from. In the present figure, the start point of that vector is a pixel Y on the past frame 900. In many cases, the movement of the picture of the neighboring pixels is made by means of the vectors relatively near thereto. Therefore, with applying the vector, which is used by the neighboring pixels, so as to produce the new motion vector, there can be obtained an effect of achieving a picture of natural movement, with reducing the dynamic false contours while preventing the omission of the light-ON information within the sub-field.

In this instance, a candidate pixel to be applied with the motion vector should not be restricted to that mentioned above. For example, the new motion vector may be produced with using the pixel, such as, the pixel XR(j+1,k) neighboring in the right-hand direction, pixels XU(j,k−1) and XD(j,k+1) neighboring upward and downward, or the motion vector ending at the pixel neighboring in the oblique direction, for example.

Selection of the pixel, to which the motion vector should be applied, may be made from among the pixels, each having that motion vector, upon determination of the presence of the motion vector ending at the candidate pixel. Or, in case where there are plural numbers of pixels, each having that motion vector, among those candidate pixels, for example, selection may be made by giving priority to those pixels or the motion vectors. As an example of the priority, the pixel, on which production of the motion vector is completed, may be selected prior to the present pixel. If making the selection in this manner, for example, since the motion vector was already produced, then it is possible to accelerate the processing thereof.

Also, in case where the detection process of the motion vector and the disposing process of the light-ON pattern information of SF are conducted in the order, the pixel XL, the pixel X, and the pixel XR, for example, the process of the pixel XL is conducted just before processing the pixel X. Herein, in particular, bringing the pixel XL, on which the motion vector is produced just before, to be the highest in the priority thereof, results the following effect. Thus, for example, that motion vector is stored in a memory provided within the intermediate SF frame producer portion 105 or the memory 111 shown in FIG. 1, etc., temporarily. With doing this, since data of that motion vector to be used in the processing of the pixel X is the data that is used just before, then there is no necessity of storing it within the memory for a long time-period, thereby enabling an effective processing thereof.

Also, in case where all of the pixels neighboring thereto have no such motion vector, then the candidate pixel maybe broaden up to the pixels separated from, for example, by a distance of one (1) pixel.

With the method shown in the above, irrespective of presence of the motion vector starting from the past frame 900 and ending at the pixel X(j,k), it is possible to detect or produce the motion vector to be used in disposition of the light-ON pattern information of SF.

Also, with using the detected motion vector or the produced motion vector as was mentioned above, also regarding any pixel X(j,k) on an intermediate frame 1000 for SFi, it is possible to dispose the light-ON pattern information within the i^{th} sub-field of the pixel on the past frame 900, as the light-ON pattern information at the pixel X(j,k) on the intermediate frame for SFi.

Therefore, with doing the disposition of the light-ON pattern information as shown in FIG. 10(c), it is possible to prevent the sub-field from omission of the light-ON information therein, as well as, bringing the light-ON pattern information for each SF of the past frame to be close to the motion vector in accordance with the movement of the line of sight of the user. With this, both can be achieved, i.e., reduction of the dynamic false contour and prevention of the sub-field from omission of the light-ON information therein, on the picture display relating to the video signal, which is inputted from the video signal processor apparatus 100, and thereby bringing about an effect of enabling to display the picture with high picture quality.

Next, the production of the motion vector explained in the above is conducted for every pixels on the intermediate frame for SFi. An example of this will be shown in FIG. 10(d). An arrow 1041 in FIG. 10(d) indicates an example of an order or sequence of the pixels, to be conducted with the production of the motion vector and the disposing process of the light-ON pattern information within the sub-field. In the example shown in FIG. 10(d), the process on each pixel is executed, starting from the pixel at the end on the left-hand side and into the right-hand direction. Next, when the process is completed up to the pixel at the end of the right-hand side, then the process is conducted on the pixel at the end of the left-hand side of the raw lower than that by one (1), and thereafter this is executed, repetitively. With doing this, it is possible to dispose the light-ON pattern information of SF for every pixel. Accordingly, it is possible to prevent the omission of the SF light-ON pattern information, and thereby to remove failure or vacancy of the SF light-ON pattern information.

In case when conducting the process in such the order or sequence, the priority for selecting the pixel, to which the motion vector shown in FIG. 10(c) should be applied, is made to be the highest, such as, the pixel XL(j−1,k) on the left of the X(j,k), for example. With doing this, it comes to be the pixel that is conducted with the process just before, thereby brining about an effect of shortening the period for temporarily holding the motion vector data.

Also, in this instance, the pixel XL(j,k) on the left of the X (j,k) in FIG. 10(c) was processed just before, and the upper pixel XU(j,k−1) and the pixels on both sides of that XU(j,k−1) are also on a raw upper by one (1), upon which the process was already finished. Accordingly, each of the pixels, i.e., every one of the pixel XL(j−1,k) on the left, and the pixels XU(j,k−1) and on both sides of that XU(j,k−1) is completed with the process of producing the motion vector and applying thereof. Therefore, with using those pixels to be the candidate pixels of applying the motion vector therein, it is possible to lessen the data to be stored temporarily, while applying the motion vector of the pixel much closer thereto, and thereby to conduct the process effectively much more. However, in case when setting up such the candidate pixels as was mentioned above, from the candidate pixels may be excluded the pixel, upon which the process was already conducted with applying the motion vector therein.

However, a route of the process should not be limited to the arrow 1041, but may be any kind of route.

Next, the disposition of the light-ON pattern information of SF is conducted for all of the pixels, from the intermediate frame 921 for SF1 up to the intermediate frame 928 for SF8, in such manner as was mentioned, respectively. With doing this, it is possible to prevent the SF light-ON pattern information from being omitted from, for every pixel within all the intermediate frames, and thereby to remove the vacancy of the light-ON pattern information of SF.

Therefore, according to the intermediate SF frame producer portion and the processing method thereof, according to the present embodiment, which was explained in the above, it is possible to dispose and produce the light-ON information for each of the sub-fields, from the video information inputted, with using the motion vectors, but without the omission thereof.

Also, in the explanation mentioned above, the disposition of the light-ON pattern information of SF was explained conducted for “every pixel” in each intermediate frame, for the purpose of easy explanation thereof. However, “every pixel” mentioned herein does not indicate, necessarily, the entire screen. It is assumed to indicate all of the pixels within a predetermined area or region, for example, a predetermined area where the dynamic false contour reducing process is conducted with using the motion vectors, the entire resolutions of the motion picture signal by a unit of frame data, or a pixel region of predetermined size, etc. Herein, as an example of determination of the pixel region of the predetermined size, for example, in the structural example shown in FIG. 1, the input portion 101 or the controller portion 110 may acknowledge the resolution or the size of the video inputted, and the controller 110 may transmit an instruction to the intermediate SF frame producer portion 105. Or, the controller 110 may transmits the instruction to the intermediate SF frame producer portion 105, with using the information, such as, the region, the resolution and the size, which are held in the memory in advance.

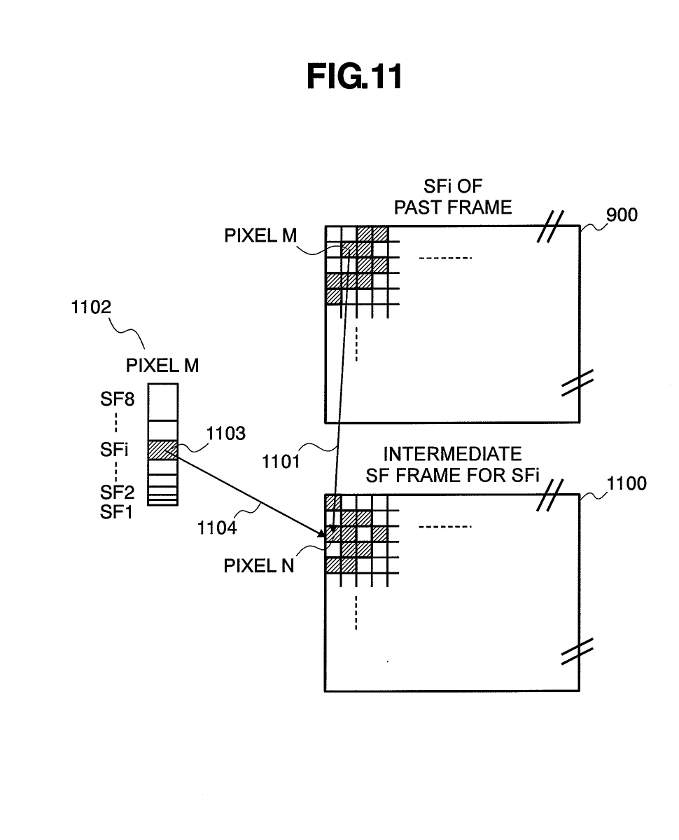

FIG. 11 is a view for showing an example of the intermediate SF frame, upon which the disposing process of the SF light-ON pattern information. This FIG. 11 shows an example of the intermediate SF frame, which is produced with conducting the disposing process of the SF light-ON pattern information shown in FIG. 10(a) to 10(d). In the present figure is shown an intermediate SF frame 1100 for SFi, for example. At the i^{th} position of each pixel of the intermediate SF frame for SF is disposed the light-ON pattern information at the i^{th} SF of the past frame, after being treated with the processes shown in FIGS. 10(a) to 10(d). Each data is constructed with value data, including data indicative of light ON and indicative of light OFF, for example. In FIG. 11, a slanted portion indicates to light ON and an empty or vacant portion not to light ON (i.e., light OFF), respectively.

Herein, a motion vector 1101 is the motion vector, ending at the pixel N of the intermediate SF frame for SFi while starting from the pixel M of i^{th} SF of the past frame 900. In this instance, the light-ON pattern information 1103 of SFi of the SF light-ON pattern information 1102 of the pixel M of the past frame 900 is disposed, as the light-ON pattern information of the pixel N of the intermediate frame 1100 for SFi, as shown by an arrow 1104.

With doing as was mentioned above, the intermediate SF frame 1100 for SFi shown in FIG. 11 is produced, for example, in the form of binary data indicative of light-ON pattern information.

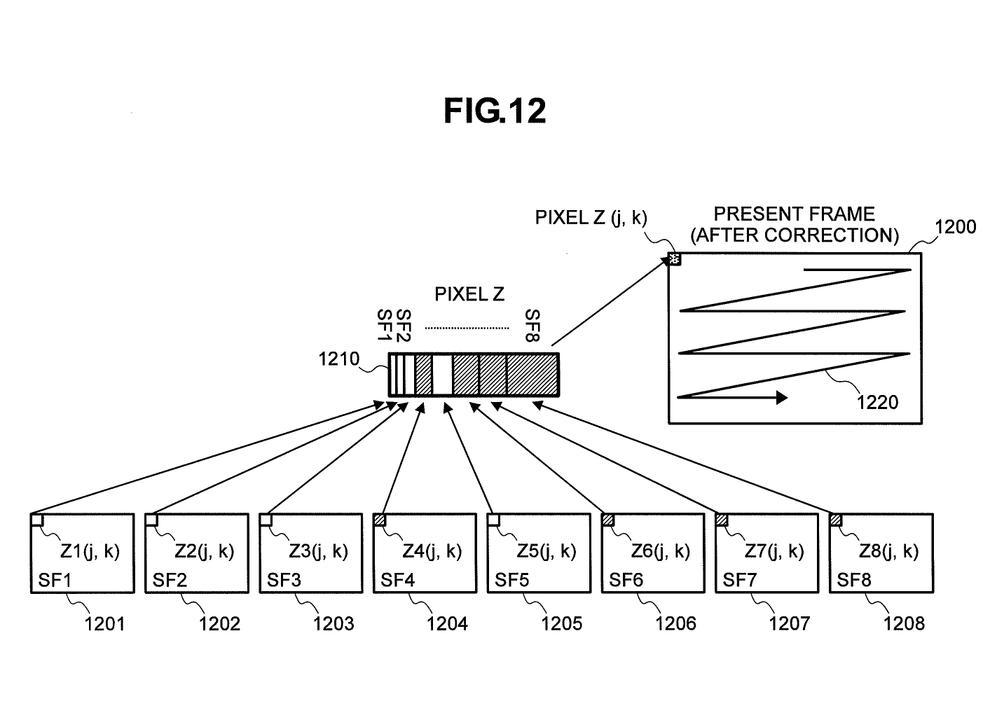

Next, explanation will be made on an example of steps for building up the present frame after correction thereof, from the intermediate SF frame. The process shown in FIG. 12 is conducted within the SF light-ON pattern signal corrector portion 106. This SF light-ON pattern signal corrector portion 106 re-constructs the light-ON pattern information in SF of each pixel of the present frame, with using the light-ON pattern information of the intermediate SF frame, which is produced with the process shown in FIG. 10(a) to 10(d).

In FIG. 12, the intermediate SF frames for SF1 to SF8 are shown by reference numerals from 1201 to 1208, respectively. Herein, the SF light-ON pattern signal corrector portion 106 re-constructs the light-ON pattern information in each sub-field of the sub-field light-ON pattern information 1210 of a pixel Z(j,k) at the position (j,k) of the present frame, with using the information of the intermediate SF frames 1201 to 1208. Thus, the SF light-ON pattern signal corrector portion 106 applies the light-ON pattern information recorded in the pixel Z(j,k) locating at the position (j,k) on the i^{th} intermediate SF frame to be the light-ON pattern information in the i^{th} sub-field of the pixel Z(j,k) locating at the position (j,k) on the present frame. This is done upon all the intermediate SF frames, thereby re-constructing all of the SF light-ON pattern information of the pixel Z(j,k) locating at the position (j,k) on the present frame.

Such re-construction of the SF light-ON pattern information of the pixel Z (j,k) as was mentioned is conducted on all the pixels of the present frame, for example, and with this, the SF light-ON pattern information of the present frame after correction is re-constructed.

However, such producing process of the SF light-ON pattern information of the pixel Z(j,k) as was mentioned above maybe made, for example, by conducing the producing process while moving the target pixel as indicted by an arrow 1220 within the present frame.

With doing in this manner, it is possible to do the disposition from the video information inputted with using the motion vector, and also to produce the new SF light-ON pattern signal, which is re-constructed from a plural number of the intermediate SF frames having no omission thereof. With this, it is possible to produce the SF light-ON pattern signal, for achieving the both, i.e., reduction of the dynamic false contour and prevention of omission of the light-ON pattern information in the sub-field.

The expression “all the pixels” and a method for determining the pixels to be the targets of the “all the pixels” have the same meaning to those explained in FIGS. 10(a) to 10(d).

The SF light-ON pattern signal, which is produced within the SF light-ON pattern signal producer portion 103, is re-constructed and corrected through the process of the intermediate SF frame producer portion 105 shown in FIGS. 10(a) to 10(d) and the process of the SF light-ON signal pattern signal corrector portion 106.

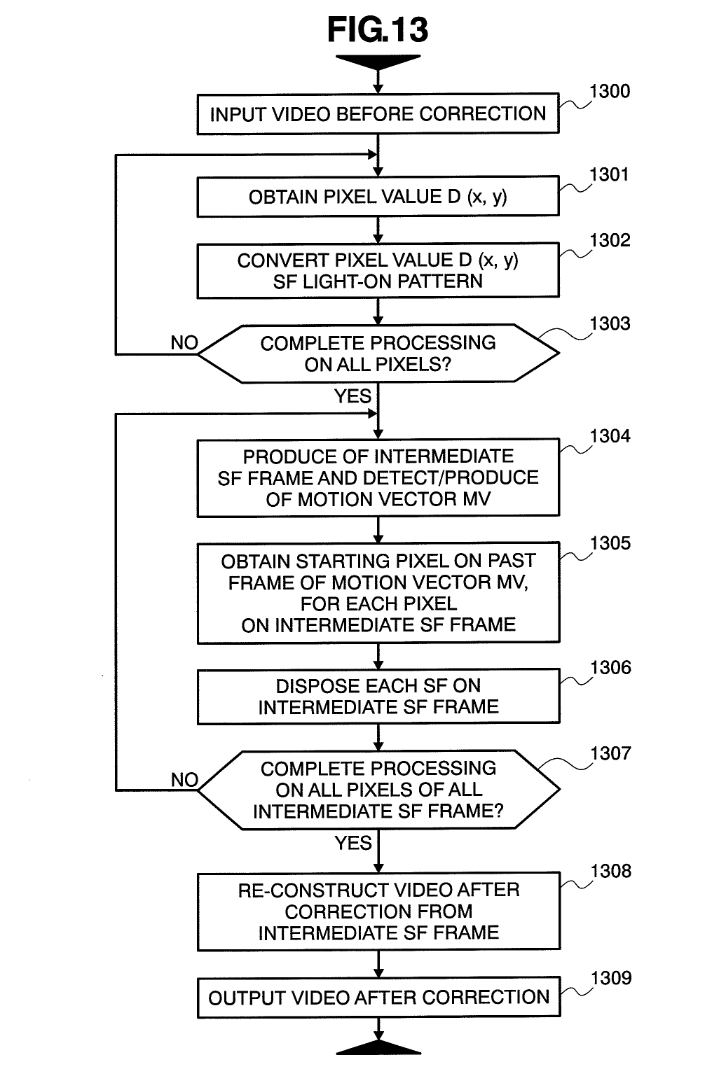

Next, explanation will be made on an example of an operation flow with the video signal processor apparatus 100, according to the present embodiment, by referring to FIG. 13. This FIG. 13 is a view for showing the example of the operation flow of the video signal processor apparatus 100, according to the present embodiment. In this FIG. 13, explanation will be made on the operation flow when outputting the video corrected for one (1) frame.

Firstly, the input portion 101 inputs the video before correction (step 1300). In this instance, if necessary, the video signal processor portion 102 conducts the signal processing, such as, the gain adjustment and the reverse gamma (“γ”) correction, etc., depending the pixel value of the input video. Next, the SF light-ON pattern signal producer portion 103 obtains the value D(x,y) of the pixel at the position (x,y) on the present frame of the video obtained in the step 1300 (step 1301), and it is converted into the SF light-ON pattern signal (step 1302). Determination is made on whether the SF light-ON pattern signal producer portion 103 completes or not the conversion process, for all the pixels into the SF light-ON pattern in the step 1302 (step 1303). If it is not yet completed, the process is conducted from the step 1302, again, but changing the position (x,y) of the pixel to be processed, thereby continuing the process. Thus, the SF light-ON pattern signal producer portion 103 repeats this until when the process is completed on all the pixels of the present frame. Next, when converting the pixel values of all pixels into the SF pattern signals, the repetition of the steps 1301 to 1303 is stopped. Next, the process shifts into a step 1304. In this instance, the condition for shifting into the step 1304 may be that the pixel values of all the pixels are converted into the SF light-ON pattern signals, completely. However, shifting into this step 1304 may be started, even if the pixel values of all the pixels are not yet converted into the SF light-ON pattern signals, completely, i.e., starting the step 1304 at time point when converting the pixel values of all the pixels into the SF light-ON patter signals in a part thereof. In this instance, the repetitive processing of the steps 1301 to 1303 and the processing after the step 1304 are conducted in parallel with. Also, in this case, there is no change in that, the repetitive processing of the steps 1301 to 1303 stops the repetition thereof, when converting the pixel values of all the pixels into the SF light-ON pattern signals.

Next, explanation will be made on the processing after the step 1304. The intermediate SF frame producer portion 105 produces the intermediate SF frame corresponding to each SF of the SF light-ON pattern signal, which is produced by the SF light-ON pattern signal producer portion 103. Also, in this instance, the intermediate SF frame producer portion 105 detects the motion vector MV ending at each pixel of each intermediate frame, with using the motion vector detected by referring between the present frame and the past frame. In this instance, with the pixel, on which the motion vectors is not yet detected, the motion vector is produced, with applying the motion vector MV of other pixel, etc. (step 1304). Next, the intermediate SF frame producer portion 105 obtains the pixel position on the past frame (step 1305), from which starts the motion vector MV ending at the pixel on the intermediate SF frame, from the motion vector MV. Next, the intermediate SF frame producer portion 105 disposes the light-ON pattern information of the pixel on that past frame (step 1306) to the pixel on that intermediate SF frame of the present frame, i.e., the end point of the motion vector MV. Next, the intermediate SF frame producer portion 105 determines on whether the disposition of the light-ON pattern information is completed or not for all the pixels of all the intermediate SF frames (step 1307). If it is not completed, yet, then the intermediate SF frame and the position of the pixel are changed, thereby carrying out the processing starting from the step 1304, again. The steps 1304 to 1307 are repeated, until when the disposition of the light-ON pattern information is completed, to all of the pixels of all of the intermediate SF frames. Next, the process shifts into a step 1308. In this instance, the condition for shifting into the step 1308 may be the completion of the disposition of the light-ON pattern information to all the pixels of all the intermediate SF frames. However, shifting into this step 1308 may be made, even if the disposition is not yet completely ended of the light-ON pattern information to all the pixels of all the intermediate SF frames, i.e., the step 1308 may be started at the time point when disposition of the light-ON pattern information is made only upon a part of the pixels of a part of the intermediate SF frames. In this instance, the repetitive processing of the steps 1304 to 1307 and the processing after the step 1308 may be conducted in parallel with. Also in this case, there is no change that, the repetitive processing of the steps 1304 to 1307 ends the repetition thereof when completing the disposition of the light-ON pattern information of SF in all the pixels.

Next, explanation will be made on the steps after the step 1308. The SF light-ON signal pattern signal corrector portion 106 disposes the sub-field light-ON pattern information of each pixel of each of the intermediate SF frames, which are produced in the step 1307, to each sub-field of the video on the present frame after the correction thereof, and thereby producing the light-ON pattern signals of the present frame after the correction (step 1308). Next, if necessary, the format converter portion 107 conducts the process of multiplying the video re-constructed with the sync signal, etc., and the output portion 108 outputs the video signals of the present after correction (step 1309).

The following operation flow is for outputting the corrected video for one (1) frame of the input video signal, and in case when outputting the video outputs for a plural number of frames, it is enough to repeat the steps from 1300 to 1308, or the steps from 1300 to 1309. In case when conducting this repetition, it is not always necessary to conduct the steps from 1300 to 1308, or the steps from 1300 to 1309, continuously. For example, a part of the steps may be repeated on the plural number of frames, while conducting a next part of the steps on the plural number of frames, in the similar manner. Those steps may be conducted, in parallel with.

Herein, it can be said that the operation flow starting from the step 1301 to the step 1303 is for converting from the input video signal to the SF light-ON pattern signal (i.e., producing the SF light-On pattern signal). Also, that from the step 1304 to the step 1309 is for a flow for the signal correction process for correcting the SF light-ON pattern signal, which is produced in the step 1303.

The operation flow was explained to be independent operations of the respective constituent elements, but the controller portion 110 may conduct it in cooperation with software recording in the memory 111.

Also, the determining process in the step 1303 and the step 1307 is achieved by making decision on whether all the pixels of the frame are completed or not, in the above explanation. The expression “all the pixels” has the meaning same to that of “all the pixels” explained in FIGS. 10(a) to 10(d).

Also, with the video signal processor apparatus according to the one embodiment of the present invention or the operation flow according to the one embodiment of the present invention, it is possible to achieve the display apparatus for displaying the video thereon, with high picture quality much more, from the video information inputted, while also achieving both, i.e., reduction of the dynamic false contour and prevention of omission of the light-ON information in the sub-field.

### EMBODIMENT 2

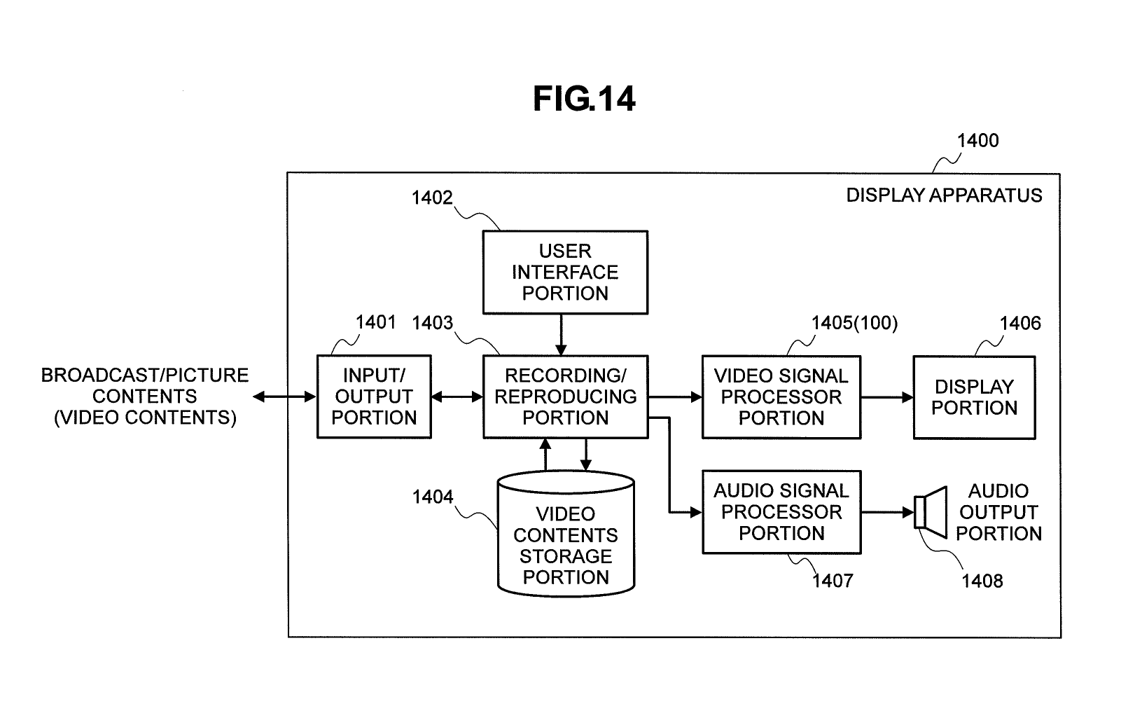

FIG. 14 shows an example of the display apparatus, applying therein the video signal processing apparatus or the video signal processing method according to the embodiment mentioned above, as a second embodiment. In the embodiment of this FIG. 14, the display device 1400 is that using the sub-field light-ON pattern information, for example, such as, a plasma television apparatus or the like, enabling to conduct the gradation expression of brightness of the pixel, with using the sub-field light-ON pattern information, for example.

In the present embodiment, the display device 1400 is constructed with an input portion 1401, for controlling the operation of inputting the video contents, such as, through download of the video contents existing on the Internet, or the operation of outputting the video contents recorded by the plasma television apparatus into an outside thereof, a video contents storage portion 1404, for storing the video contents recorded therein, a recording/reproducing portion 1403 for controlling the recording and reproducing operations, a user interface portion 1402 for receiving the operation by the user, a video signal processor portion 1405 for processing the video to be reproduced in accordance with a predetermine order of steps, an audio signal processor portion 1407 for processing the audio signal to be reproduced in accordance with a predetermined order of steps, a display device 1406 for displaying the video thereon, and an audio output portion 1408, such as, speakers for outputting an audio therefrom. The video signal processor portion 1405 is that of installing the video signal processor apparatus 100 according to the embodiment 1 into the display device 1400, for example.

Herein, if the display device is the plasma television apparatus, then the display portion 1406 may be made of a plasma panel, for example.

Also, according to the one embodiment of the present invention explained in the above, it is possible to achieve the display apparatus for conducting the video display with high picture quality much more, while also achieving both, i.e., reduction of the dynamic false contour and prevention of omission of the light-ON information in the sub-field.

### EMBODIMENT 3

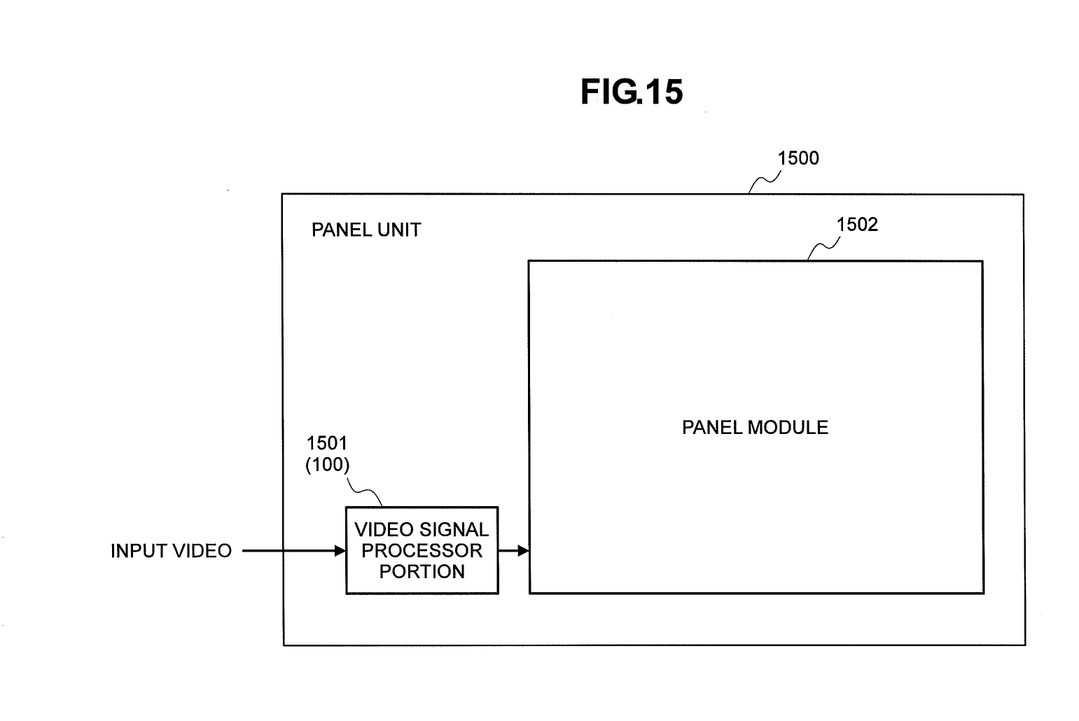

FIG. 15 shows an example of a panel unit with using the video signal processing apparatus and the video signal processing method according to the present embodiment, as a third embodiment of the present invention. Herein, as an example of the panel unit according to the present embodiment maybe, such as, a plasma panel including the video signal processing function within the plasma television apparatus, etc.

The panel unit 1500 installs a panel module 1502, and also a video signal processor device, for example, in the form of the video signal processor portion 1501. Herein, the video signal processor portion 1501 according to the present embodiment may be, such as, the display device 1400 installing the video signal processing apparatus 100 according to the embodiment 1, into the display device 1400, for example. Also, as the panel module 1502 may comprises a plural number of light-emitting elements and a light-On controller portion or a light-ON driver portion for those light-emitting elements, for example.

Also, according to the one embodiment of the present invention explained in the above, it is possible to achieve the panel unit for displaying the video thereon with high picture quality much more, while also achieving both, i.e., reduction of the dynamic false contour and prevention of omission of the light-ON information in the sub-field.

Also, it is possible to obtain an embodiment according to the present invention, with using it in combination with any one of the embodiments explained in the above.

Also, the one embodiment of the present invention can be applied into, for example, a television apparatus mounting a plasma panel, and other than that, such as, a display apparatus using the sub-field light-ON pattern information therein, or a panel unit using the sub-field light-ON pattern information therein, etc.

According to the various embodiments explained in the above, it is possible to achieve a video display of high picture quality, with achieving both, i.e., reducing the dynamic false contour and preventing the sub-field from omitting the light-ON information thereof.

What is claimed is:

1. A video signal processing method, for dividing one (1) field period in an input video into a plural number of sub-field periods, and producing a signal for controlling light-ON or -OFF during each period of said plural number of sub-periods, comprising the following steps of:
a step, which is configured to produce a sub-field light-ON pattern signal for controlling light-ON or -OFF at a pixel, during said plural number of sub-field periods, depending a pixel value of said pixel in said input video; and
a signal correcting step, which is configured to correct said sub-field light-ON pattern signal, with using a motion vector obtained through a motion vector search, which is conducted on a first frame in said input video and a second frame, time-sequentially prior to said first frame, wherein
said sub-field light-ON pattern signal has light-ON pattern signal for each pixel during each of the sub-field periods between said second frame and said first frame, and said signal correcting step determines the light-ON pattern information of one pixel during one sub-field period, with using a motion vector passing said one pixel within said sub-field among said motion vectors, while determining light-ON pattern information during said one sub-field of said one pixel when there is no motion vector passing through said one pixel, whereby producing a new sub-field light-ON pattern signal having the light-ON pattern information newly determined.

2. The video signal processing method, as described in the claim 1, wherein said signal correcting step determines the light-ON pattern information for all of the pixels in each of the sub-fields between said first frame and said second frame.

3. The video signal processing method, as described in the claim 1, wherein said signal correcting step produces a motion vector starting from said second frame and ending at said one pixel within said one sub-field, from the motion vectors passing through said one pixel during said one sub-field period, and applies the light-ON pattern information of the pixel on said second frame, from which said motion vector starts, to be new light-ON pattern information during said one sub-field of said one pixel, at which said motion vector ends.

4. The video signal processing method, as described in the claim 1, wherein said signal correcting step produces a motion vector staring from said second frame and ending at other pixel during said one sub-field, from the motion vectors passing through said other pixel during said one sub-field period, when there is no motion vector passing through said one pixel, and produces a new motion vector ending at said one pixel, similar to said motion vector, whereby applying the light-ON pattern information of the pixel on said second frame, from which said motion vector starts, to be new light-ON pattern information during said one sub-field period of said one pixel.

5. The video signal processing method, as described in the claim 4, wherein said other pixel is neighboring to said one pixel.

6. The video signal processing method, as described in the claim 4, wherein the frame of said input video has a plural number of rows, each being made of pixels disposed in horizontal direction, and the process for determining said light-ON pattern information in said signal correcting step is conducted in a process of moving from an upper row to a lower row on the frame of said input video, while moving from a left-hand side pixel to a right-hand side pixel on said raw, wherein said other pixel is any one of pixels, including a pixel neighboring to said one pixel in a left-hand side direction, a pixel neighboring to said one pixel in an upper direction, and a pixel neighboring to said pixel neighboring in the upper direction, in a left-hand side direction or a right-hand direction.

7. A video signal processing apparatus, for dividing one (1) field period in an input video into a plural number of sub-field periods, and producing a signal for controlling light-ON or -OFF during each period of said plural number of sub-periods, comprising:
a sub-field light-ON pattern signal producing unit, which is configured to produce a sub-field light-ON pattern signal for controlling light-ON or -OFF at a pixel, during said plural number of sub-field periods, depending a pixel value of said pixel in said input video; and
a signal correcting unit, which is configured to correct said sub-field light-ON pattern signal, with using a motion vector obtained through a motion vector search, which is conducted on a first frame in said input video and a second frame, time-sequentially prior to said first frame, wherein
said sub-field light-ON pattern signal has light-ON pattern signal for each pixel during each of the sub-field periods between said second frame and said first frame, and
said signal correcting unit determines the light-ON pattern information of one pixel during one sub-field period, with using a motion vector passing said one pixel within said sub-field among said motion vectors, while determining light-ON pattern information during said one sub-field of said one pixel when there is no motion vector passing through said one pixel, whereby producing a new sub-field light-ON pattern signal having the light-ON pattern information newly determined.

8. The video signal processing apparatus, as described in the claim 7, wherein said signal correcting unit determines the light-ON pattern information for all of the pixels in each of the sub-fields between said first frame and said second frame.

9. The video signal processing apparatus, as described in the claim 7, wherein said signal correcting unit produces a motion vector starting from said second frame and ending at said one pixel within said one sub-field, from the motion vectors passing through said one pixel during said one sub-field period, and applies the light-ON pattern information of the pixel on said second frame, from which said motion vector starts, to be new light-ON pattern information during said one sub-field of said one pixel, at which said motion vector ends.

10. The video signal processing apparatus, as described in the claim 7, wherein said signal correcting unit produces a motion vector staring from said second frame and ending at other pixel during said one sub-field, from the motion vectors passing through said other pixel during said one sub-field period, when there is no motion vector passing through said one pixel, and produces a new motion vector ending at said one pixel, similar to said motion vector, whereby applying the light-ON pattern information of the pixel on said second frame, from which said motion vector starts, to be new light-ON pattern information during said one sub-field period of said one pixel.

11. The video signal processing apparatus, as described in the claim 10, wherein said other pixel is neighboring to said one pixel.

12. The video signal processing apparatus, as described in the claim 10, wherein the frame of said input video has a plural number of rows, each being made of pixels disposed in horizontal direction, and the process for determining said light-ON pattern information in said signal correcting unit is conducted in a process of moving from an upper row to a lower row on the frame of said input video, while moving from a left-hand side pixel to a right-hand side pixel on said raw, and
said other pixel is any one of pixels, including a pixel neighboring to said one pixel in a left-hand side direction, a pixel neighboring to said one pixel in an upper direction, and a pixel neighboring to said pixel neighboring in the upper direction, in a left-hand side direction or a right-hand direction.

13. A display apparatus, for dividing one (1) field period in an input video into a plural number of sub-field periods, and producing a signal for controlling light-ON or -OFF during each period of said plural number of sub-periods, thereby displaying a video thereon, comprising:
a sub-field light-ON pattern signal producing unit, which is configured to produce a sub-field light-ON pattern signal for controlling light-ON or -OFF at a pixel, during said plural number of sub-field periods, depending a pixel value of said pixel in said video inputted; and
a signal correcting unit, which is configured to produce a plural number of intermediate frames between a present frame and a past frame in said video signal inputted, depending on said plural number of sub-field periods, and conducts a storing process on data of one pixel of one intermediate frame among said plural number of intermediate frames, for storing light-ON pattern information during the sub-field period corresponding to said one intermediate frame of one pixel of said past frame, thereby producing a new sub-field light-ON pattern signal, with using the light-ON pattern information to be stored to said plural number of intermediate frames, upon which said storing process is conducted; and
a display portion, which is configured to display a video thereon, with using said new sub-field light-ON pattern signal.

14. The display apparatus, as described in the claims 13, wherein said signal correction unit conducts said storing process on all of the pixels of all intermediate frames of said plural number of intermediate frames.

15. The display apparatus, as described in the claims 13, further comprising:
a vector detection unit, which is configured to detect a plural number of motion vectors, each starting from said past frame, by referring to said present frame and said past frame, wherein
if there is a motion vector ending at said one pixel of said one intermediate frame among said plural number of motion vectors, said signal correcting unit stores data of said one pixel of said one intermediate frame on said past frame, from which said motion vector starts, on the other hand if there is no motion vector ending at said one pixel of said one intermediate frame among said plural number of motion vectors, it stores light-ON pattern information during the sub-field period corresponding to said one intermediate frame of a pixel on said past frame, which is selected with using the motion vector ending at other pixel of said one intermediate frame, to be data of said one pixel of said one intermediate frame.

16. The display apparatus, as described in the claims 15, wherein said signal correcting unit produces a new motion vector ending at said one pixel, similar to the motion vector ending at said one pixel of said one intermediate frame, in case where there is no motion vector ending at said one pixel of said one intermediate frame among said plural number of motion vectors, and stores light-ON pattern information during the sub-field corresponding to said one intermediate frame of the pixel on said past frame, from which said new motion vector starts, to be the data of said one pixel of said one intermediate frame.

18. The display apparatus, as described in the claim 15, wherein the frame of said input video has a plural number of rows, each being made of pixels disposed in horizontal direction, and the process for determining said light-ON pattern information in said signal correcting step is conducted in a process of moving from an upper row to a lower row on the frame of said input video, while moving from a left-hand side pixel to a right-hand side pixel on said raw, wherein said other pixel is any one of pixels, including a pixel neighboring to said one pixel in a left-hand side direction, a pixel neighboring to said one pixel in an upper direction, and a pixel neighboring to said pixel neighboring in the upper direction, in a left-hand side direction or a right-hand direction.
